(19) United States
(12) Patent Application Publication
(10) Pub. No.: US 2016/0059378 A1
(43) Pub. Date: Mar. 3, 2016

(54) POLISHING PAD PRODUCTION METHOD

(71) Applicant: TOYO TIRE & RUBBER CO., LTD., Osaka (JP)

(72) Inventor: Tsuyoshi KIMURA, Osaka (JP)

(21) Appl. No.: 14/782,306

(22) PCT Filed: Feb. 24, 2014
(86) PCT No.: PCT/JP2014/054357

§ 371 Date: Oct. 2, 2015

(30) Foreign Application Priority Data
Apr. 12, 2013 (JP) 2013-084043

(51) Int. Cl. B24B 37/24; C08J 9/00

(52) U.S. Cl. CPC B24B 37/24; C08J 9/00; C08J 2375/08

(57) ABSTRACT

The present invention is directed to a method for producing a polishing pad having a polishing layer comprising a sheet of a flexible polyurethane resin foam, the flexible polyurethane resin foam having an Asker D hardness of 30 or less at 25° C., and the method comprising: step A of cooling a block comprising the flexible polyurethane resin foam to be adjusted into an Asker D hardness of 35 or more; and step B of slicing the block, the Asker D hardness of which has been adjusted by the cooling, into a predetermined thickness to yield the sheet of the flexible polyurethane resin foam. The method for producing a polishing pad of the present invention makes it possible to slice, with a good precision, a block comprising a flexible polyurethane resin foam.

### TECHNICAL FIELD

The present invention relates to a polishing pad used at the time of polishing a surface of, for example, optical materials including a lens and a reflecting mirror, a silicon wafer, a substrate of a compound semiconductor such as silicon carbide or sapphire, or a glass substrate or aluminum substrate for a hard disc; and a production method of the pad. The polishing pad of the invention is favorably used, in particular, as a finishing polishing pad.

### BACKGROUND ART

When a semiconductor device is produced, for example, the following steps are performed: the step of forming a conductive film on a surface of a wafer, and subjecting the resultant to photolithography, etching and other processings to form an interconnection layer; and the step of forming an interlayer dielectric onto the interconnection layer. These steps result in the generation of irregularities made of conductor such as metal, or insulator on the wafer surface. In recent years, interconnections have been becoming finer and turning into a higher-level multi-layered form for the purpose of making the integration degree of semiconductor integrated circuits higher. With this tendency, a technique for planarizing irregularities of wafer surfaces has been become important.

As a method for planarizing irregularities of wafer surfaces, adopted is generally a chemical mechanical polishing (hereinafter referred to as CMP) method. CMP is a technique of pushing the surface to be polished of a material to be polished onto a polishing surface of a polishing pad, and using, in this state, a slurry-form polishing agent in which abrasive grains are dispersed (hereinafter referred to as a slurry) to polish the surface to be polished.

The CMP is required to have a high polishing precision. Thus, a polishing pad used therein is also required to have a high thickness precision. Accordingly, a method for producing a polishing pad as described below is suggested.

Patent Document 1 discloses a method for producing a polishing pad in which a hard resin block of a polishing layer for CMP is heated to a temperature of 60 to 140° C., and the resultant is sliced with a band knife to heighten the thickness precision.

Patent Document 2 discloses a method for producing a polishing pad in which a hard resin block is heated to a temperature of 80 to 130° C., and the resultant is sliced to heighten the thickness precision.

Patent Document 3 discloses a method for producing a polishing pad in which a surface layer of a workpiece is heated to generate a difference in temperature between the surface layer and a surface slice portion thereof, and the resultant is sliced.

Patent Document 4 discloses a method for producing a polishing pad in which a hard resin block is sliced.

### PRIOR ART DOCUMENT

### Patent Documents

Patent Document 1: JP-A-2005-88157

Patent Document 2: JP-A-2005-169578

Patent Document 3: JP-A-2006-142474

Patent Document 4: JP-A-2008-302465

However, conventional conditions cause the following problems: when a resin block is soft, the resin block makes inroads into the edged tool to fail to be sliced; and when the edged tool is brought into contact with the resin block, the resin block is deformed to be lowered in thickness precision and thus the resultant polishing pad is deteriorated in polishing precision.

The present invention has been made in light of the above-mentioned problems, and an object thereof is to provide a method for producing a polishing pad capable of attaining slicing with a good precision when its resin block is a flexible polyurethane resin.

### Means for Solving the Problems

The present invention is directed to a method for producing a polishing pad having a polishing layer comprising a sheet of a flexible polyurethane resin foam, the flexible polyurethane resin foam having an Asker D hardness of 30 or less at 25° C., and the method comprising: step A of cooling a block comprising the flexible polyurethane resin foam to be adjusted into an Asker D hardness of 35 or more; and step B of slicing the block, the Asker D hardness of which has been adjusted by the cooling, into a predetermined thickness to yield the sheet of the flexible polyurethane resin foam.

### Effect of the Invention

The method for producing a polishing pad of the present invention makes it possible to slice, with a good precision, a block comprising a flexible polyurethane resin foam having an Asker D hardness of 30 or less at normal temperature (25° C.)

### BRIEF DESCRIPTION OF THE DRAWINGS

FIG. 1 is a schematic structural view illustrating an example of a polishing apparatus used in CMP polishing.

The polishing pad production method of the present embodiment is a method for producing a polishing pad having a polishing layer comprising a sheet of a soft polyurethane resin foam, wherein the flexible polyurethane resin foam having an Asker D hardness of 30 or less at 25° C., and the method comprising: step A of cooling a block comprising the flexible polyurethane resin foam to be adjusted into an Asker D hardness of 35 or more; and step B of slicing the block, the Asker D hardness of which has been adjusted by the cooling, into a predetermined thickness to yield the sheet of the flexible polyurethane resin foam.

<Step A of Cooling a Block Comprising the Flexible Polyurethane Resin Foam to be Adjusted into an Asker D Hardness of 35 or More>

### <Preparation of Polishing Layer Including Flexible Polyurethane Resin Foam Sheet>

The flexible polyurethane resin is a resin including an isocyanate component, an active hydrogen group-containing compound (a high-molecular-weight polyol or an active hydrogen group-containing low-molecular-weight compound), a chain extender, etc.

As the isocyanate component, such a compound known in the field of polyurethane is usable without any particular limitation. Examples thereof include aromatic diisocyanates such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, polymeric MDI, carbodiimide-modified MDI (for example, MILIONATE MTL (trade name) manufactured by Nippon Polyurethane Industry Co., Ltd.), 1,5-naphthalene diisocyanate, p-phenylene diisocyanate, m-phenylene diisocyanate, p-xylylene diisocyanate, and m-xylylene diisocyanate; aliphatic diisocyanates such as ethylene diisocyanate, 2,2,4-trimethylhexamethylene diisocyanate, and 1,6-hexamethylene diisocyanate; and alicyclic diisocyanates such as 1,4-cyclohexane diisocyanate, 4,4′-dicyclohexylmethane diisocyanate, isophorone diisocyanate, and norbornane diisocyanate. These may be used alone, or in any combination of two or more thereof.

Together with the diisocyanate as described above, a polymerized diisocyanate may be used. The polymerized diisocyanate is an isocyanate-modified product that is polymerized by the addition of three or more diisocyanates, or a mixture thereof. Examples of the isocyanate-modified product include 1) trimethylolpropane adduct type, 2) biuret type, and 3) isocyanurate type. The isocyanate-modified product is in particular preferably an isocyanurate type product.

In the present invention, it is preferred to use, as the isocyanate component, a polymerized diisocyanate and an aromatic diisocyanate in combination. As a diisocyanate to form the polymerized diisocyanate, an aliphatic diisocyanate is preferably used, and 1,6-hexamethylene diisocyanate is in particular preferably used. Further, urethane-modified, allophanate-modified, and biuret-modified products may be used as the polymerized diisocyanate. The aromatic diisocyanate is preferably toluene diisocyanate.

The polymerized diisocyanate is used in a proportion preferably from 15 to 60% by weight, more preferably from 19 to 55% by weight based on the whole of the isocyanate components.

Examples of the high-molecular-weight polyol include polyether polyols, a typical example thereof being polytetramethylene ether glycol; polyester polyols, a typical example thereof being polybutylene adipate; polyester-polycarbonate polyols, examples thereof including reaction products of a polyester glycol such as polycaprolactone polyol or polycaprolactone, and an alkylene carbonate; polyester-polycarbonate polyols obtained by allowing ethylene carbonate to react with a polyhydric alcohol, and next allowing the resultant reaction mixture to react with an organic dicarboxylic acid; and polycarbonate polyols obtained by a transesterification reaction between a polyhydroxyl compound and an aryl carbonate. These compounds may be used alone or in any combination of two or more thereof.

The number-average molecular weight of the high-molecular-weight polyol is not particularly limited, and is preferably from 500 to 5000 from the viewpoint of elastic properties of the resultant polyurethane resin, and others. If the number-average molecular weight is less than 500, a polyurethane resin obtained by use of this polyol does not have sufficient elastic properties, and thus the resin is a brittle polymer. Consequently, a polishing pad produced from this polyurethane resin is excessively hard, thereby causing a scratch in a wafer surface. On the other hand, if the number-average molecular weight is more than 5000, a polyurethane resin obtained by use of this polyol is too soft so that a polishing pad produced from this polyurethane resin tends to be poor in planarizing property.

Besides the high-molecular-weight polyol, the active hydrogen group-containing low-molecular-weight compound may be used. The active hydrogen group-containing low-molecular-weight compound is a compound having a molecular weight less than 500. Examples thereof include low-molecular-weight polyols such as ethylene glycol, 1,2-propylene glycol, 1,3-propylene glycol, 1,2-butanediol, 1,3-butanediol, 1,4-butanediol, 2,3-butanediol, 1,6-hexanediol, neopentyl glycol, 1,4-cyclohexanedimethanol, 3-methyl-1,5-pentanediol, diethylene glycol, triethylene glycol, 1,4-bis(2-hydroxyethoxy)benzene, trimethylolpropane, glycerin, 1,2,6-hexanetriol, pentaerythritol, tetramethylolcyclohexane, methylglycoside, sorbitol, mannitol, dulcitol, sucrose, 2,2,6,6-tetrakis(hydroxymethyl)cyclohexanol, diethanolamine, N-methyldiethanolamine, and triethanolamine; low-molecular-weight polyamines such as ethylenediamine, tolylenediamine, diphenylmethanediamine, and diethylenetriamine; and alcoholamines such as monoethanolamine, 2-(2-aminoethylamino)ethanol, and monopropanolamine. These active hydrogen group-containing low-molecular-weight compounds may be used alone or in any combination of two or more thereof.

The ratio between the high-molecular-weight polyol and the active hydrogen group-containing low-molecular-weight compound is determined in accordance with properties required for a polishing layer produced from these compounds.

When the flexible polyurethane resin is produced by a prepolymer method, the chain extender is used for curing a prepolymer. The chain extender is an organic compound having at least two or more active hydrogen groups. Examples of the active hydrogen group include a hydroxyl group, a primary or secondary amino group, and a thiol group (SH). Specific examples of the extender include polyamines such as 4,4′-methylenebis(o-chloroaniline) (MOCA), 2,6-dichloro-p-phenylenediamine, 4,4′-methylenebis(2,3-dichloroaniline), 3,5-bis(methylthio)-2,4-toluenediamine, 3,5-bis(methylthio)-2,6-toluenediamine, 3,5-diethyltoluene-2,4-diamine, 3,5-diethyltoluene-2,6-diamine, trimethylene glycol-di-p-aminobenzoate, polytetramethyleneoxide-di-p-aminobenzoate, 4,4′-diamino-3,3′,5,5′-tetramethyldiphenylmethane, 4,4′-diamino-3,3′-diisopropyl-5,5′-dimethyldiphenylmethane, 4,4′-diamino-3,3′,5,5′-tetraisopropyldiphenylmethane, 1,2-bis(2-aminophenylthio)ethane, 4,4′-diamino-3,3′-diethyl-5,5′-dimethyldiphenylmethane, N,N′-di-sec-butyl-4,4′-diaminodiphenylmethane, 3,3′-diethyl-4,4′-diaminodiphenylmethane, m-xylylenediamine, N,N′-di-sec-butyl-p-phenylenediamine, m-phenylenediamine, and p-xylylenediamine; and the low-molecular-weight polyols described above; and the low-molecular-weight polyamines described above. These may be used alone or in the form of a mixture of two or more thereof.

The flexible polyurethane foam may be produced by an application of a known urethanation technique such as a melting method or solution method, using the raw material of the polyurethane resin. The flexible polyurethane foam is produced preferably by a melting method when costs, working environments and others are considered.

The production of the flexible polyurethane foam may be attained by either a prepolymer method or a one shot method. Preferred is a prepolymer method in which an isocyanate-terminated prepolymer is synthesized from an isocyanate component and an active hydrogen group-containing compound in advance, and then a chain extender is allowed to react with this prepolymer since physical properties of the resultant polyurethane resin are excellent.

In the synthesis of the isocyanate-terminated prepolymer, the ratio of the number of isocyanate groups in the isocyanate component to that of active hydrogen groups (hydroxyl groups and amino groups) in the active hydrogen group-containing compound is preferably from 1.5 to 3.0, more preferably from 1.8 to 2.5.

In the synthesis of the isocyanate-terminated prepolymer, the NCO percent by weight is preferably adjusted to from 5 to 8% by weight, more preferably from 5.8 to 8% by weight.

The ratio between the isocyanate-terminated prepolymer and the chain extender may be variously changed depending on each molecular weight and the desired physical properties of the polishing pad. In order to yield a polishing pad having desired polishing properties, the ratio of the number of isocyanate groups of the prepolymer to that of active hydrogen groups (hydroxyl groups and amino groups) of the chain extender is preferably from 0.80 to 1.20, more preferably from 0.99 to 1.15. If the number of isocyanate groups is out of this range, there is a tendency that curing failure occurs, so that the specific gravity and hardness to be required cannot be obtained, leading to a deterioration in polishing properties.

Examples of the method for producing the flexible polyurethane foam include a method of adding hollow beads, a mechanically foaming method (for example, a mechanical frothing method), and a chemically foaming method. The individual methods may be used together. In particular, preferred is a mechanically foaming method using a silicone surfactant, which is a copolymer of a polyalkylsiloxane and a polyether. Examples of a preferred compound as the silicone surfactant include SH-192 and L-5340 (manufactured by Dow Corning Toray Silicone Co., Ltd.), B8443 and B8465 (manufactured by Goldschmidt Chemical Corporation). The silicone surfactant is preferably added at a concentration of from 0.05 to 10% by weight, more preferably from 0.1 to 5% by weight, to the polyurethane-forming raw material composition.

Thereto may be optionally added a stabilizer such as an antioxidant, a lubricant, a pigment, a filler, an antistatic agent, and any other additive.

The following will describe an example of the case of using a prepolymer method to produce a flexible polyurethane resin foam that is of an independent cells type for constituting the polishing pad (polishing layer). This method for producing the flexible polyurethane foam has the following steps:

### 1) Foaming Step of Preparing Cell Dispersion Liquid

The step includes adding a silicone surfactant to a first component containing an isocyanate-terminated prepolymer so that the polyurethane resin foam contains 0.05 to 10% by weight of the silicone surfactant and stirring the mixture in the presence of a non-reactive gas to forma cell dispersion liquid in which the non-reactive gas is dispersed in the form of fine cells. In a case where the prepolymer is solid at an ordinary temperature, the prepolymer is preheated to a proper temperature and used in a molten state.

### 2) Curing Agent (Chain Extender) Mixing Step

A second component containing a chain extender is added to the cell dispersion liquid, and these components are mixed with each other. The mixture is then stirred to prepare a foaming reaction liquid.

### 3) Casting Step

The foaming reaction liquid is cast into a mold.

### 4) Curing Step

The foaming reaction liquid poured into the mold is reaction-cured by heating to produce a flexible polyurethane resin foam block.

The non-reactive gas used for forming fine cells is preferably not combustible, and is specifically nitrogen, oxygen, a carbon dioxide gas, a rare gas such as helium or argon, and a mixed gas thereof, and air dried to remove water is most preferable in respect of cost.

As a stirring device for making the non-reactive gas into fine cells to be dispersed into the first component containing the silicone surfactant, a known stirring device is usable without any particular limitation. Specific examples thereof include a homogenizer, a dissolver, and a biaxial planet mixer (planetary mixer). The shape of a stirring blade of the stirring device is not particularly limited. A whipper-type stirring blade is preferably used to form fine cells.

It is also preferable mode to use different stirring devices in stirring for forming a cell dispersion liquid in the foaming step and in stirring for mixing an added chain extender in the mixing step. In particular, stirring in the mixing step may not be stirring for forming cells, and a stirring device not generating large cells is preferably used. Such a stirring device is preferably a planetary mixer. The same stirring device may be used in the foaming step and the mixing step, and stirring conditions such as revolution rate of the stirring blade are preferably regulated as necessary.

In the method for producing the flexible polyurethane foam, heating and post-curing of the foam obtained after casting the foaming reaction liquid into a mold, followed by reaction, until the foaming reaction liquid lost fluidity are effective in improving the physical properties of the foam, and are extremely preferable. It is allowable to use conditions for casting the foaming reaction liquid into a mold and putting the mold immediately into a heating oven to post-cure the liquid. Even under such conditions, heat is not immediately transmitted to the reaction components so that the diameters of the cells do not increase. The curing reaction is conducted preferably at normal pressure since the shape of the cells is stabilized.

In the flexible polyurethane foam, a known catalyst for promoting polyurethane reaction such as a tertiary amine catalyst, may be used. The kind and addition amount of the catalyst are selected, considering a period when the reaction liquid flows into the mold, which has a predetermined shape, after the mixing step.

The method for producing the flexible polyurethane resin foam is not particularly limited, but is preferably in a batch manner, in which each component is weighed, charged into a vessel, and then stirred.

In the method for producing the flexible polyurethane resin foam block, it is very favorable to allow a bubble-dispersed urethane composition to flow into a mold, cause the composition to undergo a reaction until the composition does not flow, heat the resultant foam, and post-cure the heated foam since this process produces an advantageous effect of improving the foam in physical properties. The temperature for the post-curing needs to be not lower than the activating temperature of a thermosensitive catalyst to be used, and is usually from about 80 to 120° C.

The average foam diameter of the flexible polyurethane resin foam is preferably from 30 to 100 μm, more preferably from 30 to 80 μm. If the diameter departs from the range, the polishing rate tends to be lowered, or a matter (wafer) to be polished tends to be lowered in planarity after polished.

The specific gravity of the flexible polyurethane resin foam is preferably from 0.6 to 0.9, more preferably from 0.7 to 0.8. If the specific gravity is less than 0.5, the polishing layer is lowered in surface strength, so that a matter to be polished tends to be lowered in planarity. If the specific gravity is more than 1.0, the number of bubbles in the front surface of the polishing layer is decreased so that the planarity is good but the polishing rate tends to be lowered.

The flexible polyurethane foam has a hardness of 30 or less at normal temperature (25° C.) according to an Asker D hardness meter. If the Asker D hardness is more than 30, scratches tend to be generated for finishing polishing. The flexible polyurethane foam has a hardness of preferably 25 or more at normal temperature (25° C.) according to an Asker D hardness meter. If the Asker D hardness is less than 25, the resin foam tends to be lowered in planarizing property.

In this step, the block including the flexible polyurethane resin foam is cooled to adjust the Asker D hardness to 35 or more.

A means for the cooling is not particularly limited. For example, the block can be cooled by storing the block in a freezer or a refrigerator for a predetermined period.

The cooling temperature is not particularly limited as far as the temperature permits the block, which includes the flexible polyurethane resin foam having an Asker D hardness of 30 or less at normal temperature (25° C.), to be adjusted into an Asker D hardness of 35 or more. The temperature ranges, for example, from 10° C. or higher and 30° C. or lower.

<Step B of Slicing Block, Asker d Hardness of which has been Adjusted by Cooling, into Predetermined Thickness to Yield Flexible Polyurethane Resin Foam Sheet>

In this step, the block, the Asker D hardness of which has been adjusted to 35 or more by the cooling, is sliced into a predetermined thickness to yield a flexible polyurethane resin foam sheet.

The manner for slicing the block, the Asker D hardness of which has been adjusted by the cooling, into the predetermined thickness is not particularly limited. Examples thereof include a band saw manner and a planer manner. The planer manner is in particular preferred from the viewpoint of productivity. It has been hitherto difficult to use the planer manner to slice a block including a flexible polyurethane resin foam into a predetermined thickness with a good precision and a good productivity. However, the method for producing a polishing pad according to the present embodiment makes it possible to slice the block with a good precision and a good productivity in the planer manner.

The variation in the thickness of the flexible polyurethane resin foam sheet is preferably 100 μm or less. If the thickness variation is more than 100 μm, the polishing layer has large undulations to have moieties different from each other in contacting state with a matter to be polished, thereby producing a bad effect onto the polishing properties. In order to cancel the thickness variation of the polishing layer, the front surface of the polishing layer is generally dressed, at an initial stage of polishing, with a dresser to which diamond abrasive grains are electrodeposited or melt-deposited. If the variation is more than the range described above, the dressing period becomes long so that the production efficiency is lowered.

An example of a method for restraining the variation in the thickness of the flexible polyurethane resin foam sheet includes a method of buffing the front surface of the sheet sliced into a predetermined thickness. In the buffing, it is preferred to use polishing materials different from each other in, for example, grain size to perform the buffing step by step.

The thickness of the flexible polyurethane resin foam sheet is not particularly limited. The thickness is usually from about 0.8 to 4 mm, and is preferably from 1.5 to 2.5 mm.

The polishing surface of the polishing layer that contacts a matter to be polished preferably has an irregularity structure for holding/renewing a slurry. The polishing layer including the foam has, in the polishing surface thereof, many openings to have a function of holding/renewing a slurry. When the irregularity structure is formed in the polishing surface, the holding/renewing of the slurry can be more efficiently attained, and further the breakdown of the matter to be polished can be prevented, the breakdown being caused by adsorption between the polishing surface and the matter to be polished. The irregularity structure is not particularly limited as far as the structure has a shape permitting the slurry to be held/renewed. Examples of the structure include XY-lattice grooves, concentric grooves, through holes, blind holes, polygonal columns, circular columns, a spiral groove, eccentric grooves, radial grooves, and any combination of two or more of these structures. These irregularity structures generally have regularity. However, in order to make the performance for holding/renewing the slurry desirable, the groove pitch, the groove width, the groove depth or the like may be varied in every certain range.

The method for forming the irregularity structure is not particularly limited. Examples thereof include a method of using a tool having a predetermined size, such as a bite, to cut the polishing surface mechanically, a method of using a press plate having a predetermined surface shape to press a resin to thereby produce the structure, a method of using photolithography to produce the structure, and a method of using laser rays, for example, carbon dioxide gas laser rays.

The polishing pad of the present invention may be a pad in which a polishing layer as above and a cushion layer are bonded to each other.

The cushion layer is a layer for compensating for properties of the polishing layer. The cushion layer is a member necessary for making both of the planarity and uniformity, which have a tradeoff relationship therebetween, compatible with each other in CMP. The planarity denotes the flatness of a patterned portion obtained at the time of polishing a material to be polished having fine irregularities generated when the pattern is formed. The uniformity denotes evenness of the whole of a material to be polished. The planarity is improved in accordance with properties of the polishing layer, and the uniformity is improved in accordance with properties of the cushion layer. In the polishing pad according to the present embodiment, it is preferred to use, as the cushion layer, a layer softer than the polishing layer.

The cushion layer is, for example, a fiber non-woven fabric such as a polyester non-woven fabric, nylon non-woven fabric or acrylic non-woven fabric; a resin-impregnated non-woven fabric such as a polyester non-woven fabric impregnated with polyurethane; a polymeric resin foam such as a polyurethane foam or polyethylene foam; a rubbery resin such as butadiene rubber or isoprene rubber; or a photosensitive resin.

Means for bonding the polishing layer and the cushion layer to each other may be, for example, a method in which a double-sided tape is sandwiched between the polishing layer and the cushion layer, followed by pressing.

The double-sided tape is a tape having an ordinary structure in which adhesive layers are provided, respectively, on both surfaces of a substrate such as a non-woven fabric or a film. Considering the prevention of the permeation of the slurry into the cushion layer, it is preferred to use a film as the substrate. The composition of the adhesive layer is, for example, that of a rubber-based adhesive or an acrylic-based adhesive. An acrylic-based adhesive is preferred, considering that the content of metal ions is small. The composition of the polishing layer may be different from that of the cushion layer; thus, it is allowable to make the respective compositions of the individual adhesive layers of the double-side tape different from each other, so that the adhesive strength of each of the layers may be appropriate.

In the polishing pad of the present invention, a double-sided tape may be provided on the surface thereof adhered to a platen. As the double-sided tape, a tape having a common structure can be used in which adhesive layers are, as described above, provided on both surfaces of a substrate. Examples of the substrate include a non-woven fabric and a film. Considering the peeling of the polishing pad from the platen after the pad is used, it is preferred to use a film as the substrate. As the composition of an adhesive layer, for example, a rubber-based adhesive or an acrylic-based adhesive is used. An acrylic-based adhesive is preferred, considering that the content of metal ions is small.

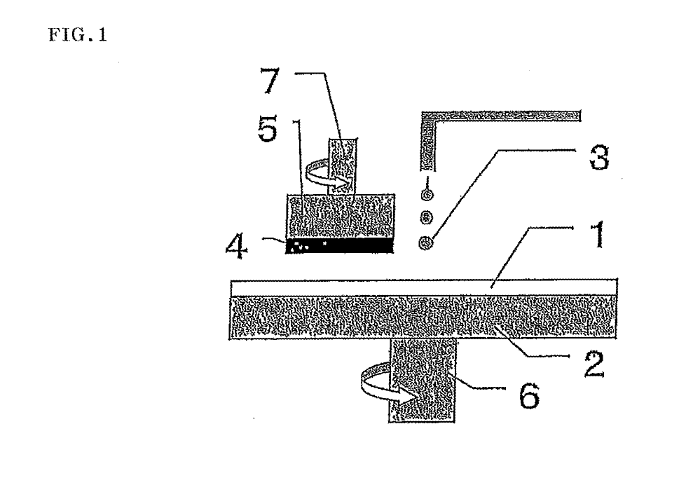

A semiconductor device is produced through the step of using the polishing pad to polish a surface of a semiconductor wafer. The semiconductor wafer is generally a member in which an interconnection metal and an oxide film are laminated onto a silicon wafer. The method and device for polishing the semiconductor wafer are not particularly limited. As illustrated in FIG. 1, the method is performed by use of, for example, a polishing apparatus equipped with a polishing platen 2 supporting a polishing pad (a polishing layer) 1, a support (polishing head) 5 holding a semiconductor wafer 4, a backing material for applying uniform pressure against the wafer and a supply mechanism of a polishing agent 3. The polishing pad 1 is mounted on the polishing platen 2 by attaching the pad to the platen with a double sided tape. The polishing platen 2 and the support 5 are disposed so that the polishing pad 1 and the semiconductor wafer 4 supported or held by the polishing platen 2 and the support 5, respectively, are opposite to each other. The polishing platen 2 and the support 5 are provided with respective rotary shafts 6 and 7. A pressure mechanism for pressing the semiconductor wafer 4 to the polishing pad 1 is installed on the support 5 side. During polishing, the semiconductor wafer 4 is polished by being pressed against the polishing pad 1 while the polishing platen 2 and the support 5 are rotated and a slurry is fed. A flow rate of the slurry, a polishing load, a polishing platen rotation number and a wafer rotation number are not particularly limited, and they are properly adjusted.

Through this process, projected portions on the surface of the semiconductor wafer 4 are removed so that the surface is polished flatly. Thereafter, the wafer is subjected to dicing, bonding, packaging and other operations. In this way, a semiconductor device is produced. The semiconductor device is used for an arithmetic processing unit, a memory, and others.

### EXAMPLES

Hereinafter, the present invention will be described by way of examples. However, the present invention is not limited to these examples.

### [Measuring and Evaluating Methods]

### (Number-Average Molecular Weight)

A number-average molecular weight was measured by GPC (gel permeation chromatography) and a value as measured was converted in terms of standard polystyrene.

GPC device: LC-10A, manufactured by SHIMADZU CORPORATION.

Columns: the following three columns connected to each other are used: column (PLgel, 5 μm, 500 angstroms), column (PLgel, 5 μm, 100 angstroms), and column (PLgel, 5 μm, 50 angstroms) each manufactured by Polymer Laboratories Inc.

Flow rate: 1.0 mL/min.

Concentration: 1.0 g/L

Injected amount: 40 μL

Column temperature: 40° C.

Eluent: tetrahydrofuran

### (Average Cell Diameter)

A prepared polyurethane foam was cut with a microtome cutter to have parallel surfaces and to be made as thin as possible to give a thickness of 1 mm or less. The cut foam was used as a sample for measuring average cell diameter. The sample was fixed on a slide glass piece, and an SEM (S-3500N, manufactured by Hitachi Science Systems Ltd.) was used to observe the sample with 100 magnifications. In the resultant image, an image analyzing software (WinRoof, manufactured by Mitani Corp.) was used to measure the respective diameters of all cells in an arbitrary range of the image. The average cell diameter thereof was calculated.

### (Specific Gravity)

Measurement was conducted in accordance with JIS Z8807-1976. A prepared polyurethane foam was cut out into a rectangular form 4 cm×8.5 cm in size (thickness: arbitrary). The resultant cut foam was used as a sample for measuring specific gravity. The sample was allowed to stand still in an environment having a temperature of 25° C. and a humidity of 50±5% for 16 hours. The specific gravity was measured, using a gravimeter (manufactured by Sartorius Co., Ltd.).

### (D Hardness of Flexible Polyurethane Resin Foam)

The measurement was made in accordance with JIS K6253-1997. A produced polyurethane resin foam sheet was cut into pieces each having a size of 2 cm×2 cm (and having any thickness). Some of the pieces were each used as a sample for hardness measurement. The samples were allowed to stand still in an environment having a temperature of 23° C.±2° C. and a humidity of 50%±5% as normal-temperature-time conditions for 8 hours. When cooled and heated, the same samples were stored in a temperature-keeping chamber having conditions identical to the cooling and heating temperature conditions for 8 hours. In the measurements, the samples were put onto each other to adjust the resultant stack into a thickness of 6 mm or more. A hardness meter (Asker D hardness meter, manufactured by Kobunshi Keiki Co., Ltd.) is used to measure each of the hardnesses.

### (Thickness Precision of Soft Polyurethane Resin Foam Sheet)

A produced polyurethane foam was cut into a piece having a size of 50 cm×50 cm. The piece was used as a sample. On the sample, straight lines were drawn in lengthwise and breadthwise directions at intervals of 5 cm. A micrometer (CLM1-15QM, manufactured by Mitutoyo Corporation) was used to measure the thickness at each intersection point thereof. In accordance with the difference between the resultant maximum value (max) and minimum value (min), the thickness precision was evaluated. A criterion for the evaluation is as follows:

◯: max−min≦50 μm

x: max−min>50 μm

### (Evaluation of State of Slice)

It was checked whether or not a produced polyurethane foam underwent an inconvenience while sliced. Moreover, a sheet surface thereof was visually observed after the slicing. It was then checked whether or not the surface had a step, a local cut, or some other defect. A criterion for the evaluation is as follows:

◯: no problem is caused in the slicing work. After the work, no step or cut is visually observed in the sheet surface.

x: during the slicing work, the instrument is stopped by, for example, overload. Alternatively, the block is clogged. Although the slicing work is attained, a step or cut is visually observed in the sheet surface.

### Example 1

### Preparation of Flexible Polyurethane Foam Block

Into a vessel were put 18.2 parts by weight of toluene diisocyanate (TDI-80, manufactured by Mitsui Chemicals, Inc.: 2,4-diisocyanate/2,6-diisocyanate=80/20), 22.5 parts by weight of polymerized 1,6-hexamethylene diisocyanate (SUMIDULE N3300, isocyanurate type, manufactured by Sumika Bayer Urethane Co., Ltd.), 57.1 parts by weight of polytetramethylene ether glycol (PTMG1000, manufactured by Mitsubishi Chemical Corporation; hydroxyl value: 112.2 KOHmg/g), and 2.2 parts by weight of 1,4-butanediol (1,4-BG, manufactured by Nacalai Tesque, Inc.), and the mixture was allowed to react at 70° C. for 4 hours to yield an isocyanate terminated prepolymer A. The content of the polymerized 1,6-hexamethylene diisocyanate is 55% by weight based on the total isocyanate components. To a polymerizing vessel were added 100 parts by weight of the prepolymer A and 3 parts by weight of a silicone surfactant (B8465, manufactured by Goldschmidt), and then these components were mixed with each other. The mixture was adjusted to 80° C. and was defoamed under reduced pressure. Subsequently, the reaction system was vigorously stirred for about 4 minutes with a stirring blade at a rotational speed of 900 rpm so that air bubbles were incorporated into the reaction system. Thereto were added 19.9 parts by weight of 4,4′-methylenebis(o-chloroaniline), which was beforehand melted to have a temperature of 120° C. This mixed liquid was stirred for 1 minute, and then cast into a pan-shaped open mold (casting vessel). The mold was put into an oven when the fluidity of this mixed liquid was lost. The resultant resin was post-cured at 100° C. for 16 hours to yield a flexible polyurethane foam block.

### (Adjustment of Asker D Hardness by Cooling)

The polishing sheets as described above were put into thermostats adjusted to respective set temperatures. Eight hours after the temperatures of the thermostats reached the respective set temperatures, the sheets were cooled and stored. The polishing sheets were stored in the thermostats immediately before sliced.

### (Slicing)

A flexible polyurethane resin foam block was cooled to 20° C. to adjust the Asker D hardness thereof, and this foam block was sliced using a slicer (VGW-125, manufactured by Amitec Corporation).

### Example 2 and Comparative Example 1

The same operations as those in Example 1 were made in each of Example 2 and Comparative Example 1 except that the flexible polyurethane resin foam block was cooled or heated to the temperatures described in Table 1 to adjust the Asker D hardness thereof.

TABLE 1

| | | | Compar- |
|---|---|---|---|
| | Exam- | Exam- | ative |
| | ple 1 | ple 2 | Example 1 |
| D hardness of flexible polyurethane resin | 26 | 26 | 26 |
| foam block at normal temperature (° C.) | | | |
| Adjusted D hardness of flexible | 35 | 38 | 21 |
| polyurethane resin foam block | | | |
| Temperature at time of adjusting D | 20 | 10 | 80 |
| hardness | | | |
| Slice state | ∘ | ∘ | x |
| Thickness precision | ∘ | ∘ | x |

From Table 1, it is understood that in the respective polishing pad production methods of Examples 1 and 2, slice can be performed with a high precision.

### INDUSTRIAL APPLICABILITY

The polishing pad production method of the present invention is usable as a method for producing a polishing pad which is for planarizing optical materials including a lens and a reflecting mirror, a silicon wafer, a glass substrate or aluminum substrate for a hard disc, and which is for attaining an ordinary metal polishing, or any other planarization of a material for which a high-level surface planarity is required.

### DESCRIPTION OF REFERENCE SIGNS

1: polishing pad
2: polishing platen
3: polishing agent (slurry)
4: a material to be polished (semiconductor wafer)
5: support (polishing head)
6 and 7: rotary axes

1. A method for producing a polishing pad having a polishing layer comprising a sheet of a flexible polyurethane resin foam,
the flexible polyurethane resin foam having an Asker D hardness of 30 or less at 25° C., and
the method comprising:
step A of cooling a block comprising the flexible polyurethane resin foam to be adjusted into an Asker D hardness of 35 or more, and
step B of slicing the block, the Asker D hardness of which has been adjusted by the cooling, into a predetermined thickness to yield the sheet of the flexible polyurethane resin foam.

2. The method for producing a polishing pad according to claim 1,
wherein in step B,
a means for slicing the block into the predetermined thickness is in a planer manner.
